(19) United States
(12) Patent Application Publication
(10) Pub. No.: US 2007/0088113 A1
(43) Pub. Date: Apr. 19, 2007

(54) Resin composite material and electronic device component

(75) Inventors: Fumiyuki Suzuki, Kanagawa (JP); Tadashi Mochizuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/544,663

(22) Filed: Oct. 10, 2006

(30) Foreign Application Priority Data
Oct. 7, 2005 (JP) 2005-294590

(51) Int. Cl. C08K 3/38; C08K 3/32

(52) U.S. Cl. 524/404; 524/414

(57) ABSTRACT

A resin composite material is provided, which contains an environment-friendly metal hydroxide flame retardant so as to have excellent flame retardancy, and an electronic device component which includes the resin composite material. The resin composite material contains an ester linked polymer, an inorganic hydroxide flame retardant, and a metal ion trap.

### CROSS REFERENCE TO RELATED APPLICATIONS

This application claims the foreign priority benefit under Title 35, United States Code, §119(a)-(d) of Japanese Patent Application No. 2005-294590, filed on Oct. 7, 2005 in the Japan Patent Office, the disclosure of which is herein incorporated by reference in its entirety.

### BACKGROUND OF THE INVENTION

1. Field of the Invention

The present invention relates to a resin composite material and an electronic device component, and more specifically, to a resin composite material with excellent flame retardancy in which a flame retardant and a resinous component are made from environment-friendly materials, and to an electronic device component including the resin composite material.

2. Description of the Related Art

Conventionally, various materials are used for components which constitute an electronic device in accordance with properties, functions, and so on required for the components. For instance, ABS (Acrylonitrile-butadiene-styrene) resin, PC (Polycarbonate)/ABS, PC, or the like is selected and used for an electronic device component in accordance with properties, behaviors, and so on which are required for the component.

On the other hand, a non-halogen flame retardant started to be used as a flame retardant instead of a halogen flame retardant in view of environmental load. A metal hydroxide is being considered to be used as the non-halogen flame retardant. In a Japanese Laid-Open Patent Application Publication JP 2004-190026 A, it is proposed that a phosphorus flame retardant, a nitrogen compound flame retardant, a silicone flame retardant, or the like is combined with a polylactic acid, that is, an ester linked polymer. However, in the case where the ester linked polymer is used as a resinous material to produce a resin molded product, the resinous material, a metal hydroxide, and other components are melted at a high temperature and molded. Then, the ester linked polymer may react with the metal hydroxide to generate a pumiceous solid substance resulting in molding failure. For instance, there is a problem that when a mixture of polylactic acid, which is the ester linked polymer, and magnesium hydroxide, which is the metal hydroxide, is heated, a solid substance is generated and molding cannot be accomplished.

### SUMMARY OF THE INVENTION

In view of the above, it is an object of the present invention to solve the above-mentioned problems and to provide a resin composite material which contains an environment-friendly metal hydroxide flame retardant contributing to flame retardancy, and an electronic device component which includes the resin composite material.

A DSC curve was obtained for a resin composition of polylactic acid used as an ester linked polymer and magnesium hydroxide used as a metal hydroxide flame retardant. As a result, a heat peak was observed at about 230° C. in the DSC curve. On the other hand, no heat peak was observed at about 230° C. in a DSC curve for polylactic acid alone or magnesium hydroxide alone. Based on these phenomena, it was inferred that decomposition of the polymer was influenced by magnesium ions originated from magnesium hydroxide used as the metal hydroxide flame retardant. Accordingly, boric acid was used as a metal ion trap to absorb the magnesium ions. Thus, the boric acid controls the resin composition of the polylactic acid used as the ester linked polymer and magnesium hydroxide used as the metal hydroxide flame retardant. Then, in the DSC curve obtained for the resin composition, no heat peak caused by reaction of the polylactic acid with magnesium hydroxide was observed at about 230° C. Therefore, the following was found out. When a metal ion trap was mixed into the resin composition containing the ester linked polymer and the metal hydroxide flame retardant, the metal ion trap absorbed metal ions originated from the metal hydroxide flame retardant. As a result, it was found that melt molding could be accomplished without any solid substance generated by reaction of the ester linked polymer with the metal hydroxide flame retardant.

In view of the above, in one aspect of the present invention, there is provided a resin composite material containing an ester linked polymer, an inorganic hydroxide flame retardant, and a metal ion trap.

The resin composite material contains the ester linked polymer, the inorganic hydroxide flame retardant, and boron as essential components, so that boron as the metal ion trap absorbs metal ions from the metal hydroxide flame retardant. Therefore, no solid substance is generated by reaction of the ester linked polymer with the metal hydroxide flame retardant in a melt molding process so that a resin molded product with excellent flame retardancy can be molded.

In the resin composite material according to the invention, at least one kind of the ester linked polymer may be selected from a group consisting of aromatic polyester, aliphatic polyester, aromatic polyester-aliphatic polyester copolymer, and polycarbonate.

In the resin composite material, at least one kind of the inorganic hydroxide flame retardant may be selected from a group consisting of magnesium hydroxide, aluminium hydroxide, and dawsonite.

In the resin composite material, at least one kind of the metal ion trap may be selected from a group consisting of boron, anhydrous boric acid, phosphate, phosphite, and zeolite.

The resin composite material may contain 100 parts by weight of the ester linked polymer, 1-200 parts by weight of the inorganic hydroxide flame retardant, and 0.0001-50 parts by weight of the metal ion trap.

Moreover, the invention provides an electronic device component including the resin composite material.

The resin composite material can be molded into the electronic device component without a solid substance generated by reaction of the ester linked polymer with the inorganic hydroxide flame retardant. Therefore, the electronic device component shows excellent flame retardancy.

### DESCRIPTION OF THE PREFERRED EMBODIMENTS

Next, a resin composite material and an electronic device component according to the present invention will be described in detail.

A resin composite material according to the present invention is a resin composition containing an ester linked polymer, an inorganic hydroxide, and a metal ion trap.

At least one kind of ester linked polymer is preferably selected from a group including aromatic polyester, aliphatic polyester, aromatic polyester-aliphatic polyester copolymer, and polycarbonate. The ester linked polymer, such as the aliphatic polyester, the aromatic polyester, the aromatic polyester-aliphatic polyester copolymer, and the polycarbonate, may be used alone or in combination of two or more thereof.

For instance, the aliphatic polyester or the aromatic polyester includes straight or branched polyester and the like.

The straight or the branched polyester is obtained by condensation polymerization of divalent carboxylate compound and dihydric alcohol. Aromatic dicarboxylic acid or aliphatic or other dicarboxylic acid may be used as the divalent carboxylic acid component. Specific examples of difunctional carboxylic acid include oxalic acid, succinic acid, adipic acid, sebacic acid, dimer acid, hexahydro terephthalic acid, phthalic acid, isophthalic acid, terephthalic acid, 2,6-naphthalene dicarboxylic acid, 2,7-naphthalene dicarboxylic acid, 1,5-naphthalene dicarboxylic acid, diphenyl ether dicarboxylic acid, diphenoxyethane-4,4-dicarboxylic acid, diphenyl sulfone dicarboxylic acid, glycolic acid, p-oxybenzoic acid, and p-oxyethoxy benzoic acid, which may be used alone or in combination of two or more thereof.

Moreover, aromatic dialcohol or aliphatic or other dialcohol may be used as the dihydric alcohol. Specific examples of difunctional alcohol include ethylene glycol, polyethylene glycol represented by HO(CH₂)ₙOH (where n is an integer from 3 to 10), isobutylene glycol, neopentyl glycol, 1,4-cyclohexanediol, 2,2-bis-4-hydroxyphenyl propane, hydroquinone, 1,5-dihydroxy naphthalene, and 2,6-dihydroxynaphthalene, which may be used alone or in combination of two or more thereof.

In addition, the aromatic polyester-aliphatic polyester copolymer is a copolymer which contains an aliphatic polyester polymerization unit and an aromatic polyester polymerization unit. Specific examples are a polymer obtained by polymerization of aromatic dicarboxylic acid and aliphatic dicarboxylic acid, dicarboxylic acid having an aromatic dicarboxylic acid unit and an aliphatic dicarboxylic acid unit, or the like with dihydric alcohol, a copolymer obtained by copolymerization of aromatic polyester with aliphatic polyester, and so on.

An ester containing polymer used in the invention preferably contains a polymer whose monomer unit is hydroxyl carboxylic acid like polylactic acid has.

Polylactic acid, which is polyhydroxy carboxylic acid, is a polymer whose main components are L-lactic acid and/or D-lactic acid. Moreover, the polylactic acid used in the invention may be polylactic acid copolymer which contains, as a part, L-lactic acid or D-lactic acid and another monomer unit. Examples of the other monomer units include: glycol compound such as ethylene glycol, propylene glycol, butanediol, heptanediol, hexanediol, octanediol, nonanediol, decanediol, 1,4-cyclohexanedimethanol, neopentyl glycol, glycerin, pentaerythritol, bisphenol A, polyethylene glycol, polypropylene glycol, and polytetramethylene glycol; dicarboxylic acid such as oxalic acid, adipic acid, sebacic acid, azelaic acid, dodecanedioic acid, malonic acid, glutaric acid, cyclohexane dicarboxylic acid, terephthalic acid, isophthalic acid, phthalic acid, naphthalene dicarboxylic acid, bis(p-carboxyphenyl)methane, anthracene dicarboxylic acid, 4,4′-diphenyl ether dicarboxylic acid, 5-sodium sulfoisophthalic acid, and 5-tetrabutyl phosphonium isophthalic acid; hydroxycarboxylic acid such as glycolic acid, hydroxypropionic acid, hydroxybutyric acid, hydroxyvaleric acid, hydroxycaproic acid, and hydroxybenzoic acid; and lactones such as caprolactone, valerolactone, propiolactone, undecalactone, and 1,5-oxepan-2-on, and so on. A percentage of the contained other monomer unit is preferably 0-30 mole percent, and more preferably, 0-10 mole percent of the total monomer units which compose the polylactic acid copolymer.

The polylactic acid can be produced by means of a publicly known method. For instance, the polylactic acid can be produced by direct polymerization of lactic acid, ring-opening polymerization of lactide which is a ring product of lactic acid, or the like. Starch obtained from corns, potatoes, or the like is saccharified, and then fermented with the lactic acid bacterium so that the lactic acid used as a monomer is produced.

Moreover, the polylactic acid may be modified. For instance, to improve heat resistance and mechanical properties, the polylactic acid may be modified with maleic anhydride, epoxy compound, amine, and so on.

Neither a molecular weight nor a molecular weight distribution of the polylactic acid is especially limited as long as the polylactic acid is substantially moldable. Meanwhile, a weight average molecular weight is usually preferably 35,000 or more and more preferably 50,000 or more. In the invention, “the weight average molecular weight” means a molecular weight in terms of polystyrene, measured by a gel permeation chromatography.

The polycarbonate is a high molecular compound which contains in its main chain as a structural unit a carbonate type structure obtained by transesterification of disubstituted carbonate and diol, reaction of phosgene and diol, or the like. The polycarbonate includes linear polycarbonate, branched polycarbonate, a complex which contains linear polycarbonate and branched polycarbonate, and so on. The linear polycarbonate or the branched polycarbonate can be obtained by copolymerization of diol and disubstituted carbonate or phosgene without or with a branching agent, as well as with an end terminator as needed.

For instance, examples of the diol include: dihydroxydiaryl alkanes, such as bis(4-hydroxyphenyl)methane, bis(4-hydroxyphenyl)phenylmethane, bis(4-hydroxyphenyl)naphthylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 2,2-bis(4-hydroxyphenyl)propane (commonly called bisphenol A), 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, and 1,10-bis(4-hydroxyphenyl)decane; dihydroxydiaryl cycloalkanes, such as 1,1-bis(4-hydroxyphenyl)cyclohexane, 1,1-bis(3,5-dichloro-4-hydroxyphenyl)cyclohexane, 1,1-bis(4-hydroxyphenyl)-3,3,5-trirethyl cyclohexane, and 2,2-bis(4-hydroxyphenyl)-1,1,1,3,3,3-hexafluoropropane, 1,1-bis(4-hydroxyphenyl)cyclodecane; dihydroxydiaryl sulfones, such as bis(4-hydroxyphenyl)sulfone, bis(3,5-dimethyl-4-hydroxyphenyl)sulfone, and bis(3-chloro-4-hydroxyphenyl)sulfone; dihydroxydiaryl ethers, such as bis(4-hydroxyphenyl)ether and bis(3,5-dimethyl-4-hydroxyphenyl)ether; dihydroxydiaryl ketones, such as 4,4′-dihydroxybenzophenone and 3,3′,5,5′-tetramethyl-4,4′-dihydroxybenzophenone; dihydroxydiaryl sulfides, such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides, such as bis(4-hydroxyphenyl)sulfoxide; dihydroxydiphenyls, such as 4,4′-dihydroxydiphenyl; and dihydroxyaryl fluorenes, such as 9,9-bis(4-hydroxyphenyl)fluorene, and so on. Moreover, besides the diol, examples may include ethylene glycol, 1,3-propanediol, 1,4-butanediol, 1,6-hexanediol, 1,4-cyclohexanediol, 4,4′-dihydroxyethoxy phenylmethane; dihydroxybenzenes, such as hydroquinone, resorcinol, and methylhydroquinon; and dihydroxynaphthalenes, such as 1,5-dihydroxynaphthalene and 2,6-dihydroxynaphthalene. These diols may be used alone or in combination of two or more thereof. Among these, 2,2-bis(4-hydroxyphenyl)propane is common.

For instance, the disubstituted carbonate compound includes diaryl carbonates, such as diphenyl carbonate, and dialkyl carbonates, such as dimethyl carbonate and diethyl carbonate. The disubstituted carbonate compound may be used alone or in combination of two or more thereof.

As for the branching agent, a compound with three or more functional groups may be used with no special limitation. Specific examples of the branching agent include phloroglucin, mellitic acid, trimellitic acid, trimellitic acid chloride, trimellitic acid anhydride, protocatechuic acid, pyromellitic acid, pyromellitic acid dianhydride, α-resorcinolacid, β-resorcinolacid, resorcinolaldehyde, trimethyl chloride, isatin bis(o-cresol), trimethyl trichloride, 4-chloroformyl phthalic anhydride, benzophenone tetracarboxylic acid, 2,4,4′-trihydroxybenzophenone, 2,2′,4,4′-tetrahydroxybenzophenone, 2,4,4′-trihydroxyphenyl ether, 2,2′,4,4′-tetrahydroxyphenyl ether, 2,4,4′-trihydroxydiphenyl-2-propane, 2,2′-bis(2,4-dihydroxy)propane, 2,2′,4,4′-tetrahydroxydiphenyl methane, 2,4,4′-trihydroxydiphenyl methane, 1-[α-methyl-α-(4′-dihydroxyphenyl)ethyl]-3-[α′,α′-bis(4″-hydroxyphenyl)ethyl]benzene, 1-[α-methyl-α-(4′-dihydroxyphenyl)ethyl]-4-[α′,α′-bis(4″-hydroxyphenyl)ethyl]benzene, α,α′,α″-tris(4-hydroxyphenyl)-1,3,5-triisopropyl benzene, 2,6-bis(2-hydroxy-5′-methylbenzyl)-4-methylphenol, 4,6-dimethyl-2,4,6-tris(4′-hydroxyphenyl)-2-heptene, 4,6-dimethyl-2,4,6-tris(4′-hydroxyphenyl)-2-heptane, 1,3,5-tris(4′-hydroxyphenyl)benzene, 1,1,1-tris(4-hydroxyphenyl)ethane, 2,2-bis[4,4-bis(4′-hydroxyphenyl)cyclohexyl]propane, 2,6-bis(2′-hydroxy-5′-isopropylbenzyl)-4-isopropylphenol, bis[2-hydroxy-3-(2′-hydroxy-5′-methylbenzyl)-5-methylphenyl]methane, bis[2-hydroxy-3-(2′-hydroxy-5′-isopropylbenzyl)-5-methylphenyl]methane, tetrakis(4-hydroxyphenyl)methane, tris(4-hydroxyphenyl)phenylmethane, 2′,4′,7-trihydroxyflavan, 2,4,4-trimethyl-2′,4′,7-trihydroxyflavan, 1,3-bis(2′,4′-dihydroxyphenyl isopropyl)benzene, tris(4′-hydroxyphenyl)-amyl-s-triazine, and so on. The branching agent may be used alone or in combination of two or more thereof.

As for the end terminator, monohydric phenols may be used, and structure thereof is not especially limited. For instance, the monohydric phenol includes p-tert-butylphenol, p-tert-octylphenol, p-cumylphenol, p-tert-amylphenol, p-nonylphenol, p-cresol, 2,4,6-tribromophenol, p-bromophenol, 4-hydroxy benzophenone, phenol, and so on. The end terminator may be used alone or in combination of two or more thereof.

An interface method or transesterification is used for a polymerization process. For instance, when the diol and the phosgene are polymerized by means of the interface method, reaction may be conducted with the branching agent and/or the end terminator in the presence of the phosgene. Meanwhile, reaction of diol with phosgene may be conducted first to obtain polycarbonate oligomer and then reaction is conducted with a branching agent or an end terminator in the absence of phosgene. Moreover, in a case of the transesterification, the branching agent and/or the end terminator are added to transesterification reaction of the diol with the disubstituted carbonate compound so as to obtain the branched polycarbonate resin.

The diol, and the phosgene or the disubstituted carbonate compound are usually polymerized, with the end terminator as needed, to obtain the linear polycarbonate. In other words, the linear polycarbonate can be produced similarly to the branched polycarbonate resin except that the branching agent is not used.

In view of balance between mechanical strength and formability, preferable polycarbonates obtained by polymerization of the diol, and the phosgene or the disubstituted carbonate compound are polycarbonate obtained by reaction of 2,2-bis(4-hydroxyphenyl)propane and diphenyl carbonate, polycarbonate obtained by reaction of 2,2-bis(4-hydroxyphenyl)propane and dimethyl carbonate, polycarbonate obtained by reaction of 2,2-bis(4-hydroxyphenyl)propane and diethyl carbonate, polycarbonate obtained by reaction of bis(4-hydroxyphenyl)methane and diphenyl carbonate, polycarbonate obtained by reaction of bis(4-hydroxyphenyl)phenylmethane and diphenyl carbonate, and so on.

In the invention, polycarbonate-polyorganosiloxane copolymer which contains a polycarbonate structural unit and a polyorganosiloxane structural unit may be used as the polycarbonate. Moreover, there may be used a polycarbonate having aromatic or aliphatic diacid or ester thereof, such as terephthalic acid, isophthalic acid, pimelic acid, suberic acid, azelaic acid, sebacic acid, decanedicarboxylic acid, adipic acid, and so on as an acid component of copolymerization. In this case, besides the carbonate type structure, a carboxylate structure is contained as a part of the main chain.

In the invention, a kind or a combination of two or more kinds of the polycarbonate obtained from the diol, and the disubstituted carbonate or the phosgene, as well as other components as needed, may be used. In particular, in the invention, polycarbonates produced without the phosgene or methylene chloride are preferable among these polycarbonates.

A melt volume-flow rate (MVR) of the polycarbonate is preferably 8-60cm³/10 min. When polycarbonate with a high MVR, whose molecular weight is low, is molded into an electronic device component, the electronic device component becomes fragile. In the invention, the melt volume-flow rate is measured under conditions of 300° C. and 1.2 kg load in compliance with JIS K 7210:1999 (ISO 1133:1997).

Moreover, a number average molecular weight (Mn) of the polycarbonate is preferably within a range of 14,000-45,000. When the number average molecular weight is less than 14,000, the molded product of the polycarbonate becomes fragile. On the other hand, when the number average molecular weight exceeds 45,000, the polylactic acid might be thermally deteriorated due to a high temperature required in molding. A gel permeation chromatography (GPC) is used to measure the number average molecular weight (Mn) of the polycarbonate. The measurement conditions are as follows. To be specific, tetrahydrofuran as a solvent and polystyrene gel are used. A converted molecular weight calibration curve previously obtained for a standard monodisperse polystyrene with a predetermined structure is used to obtain the Mn.

The polylactic acid is preferably used among the aromatic polyester, the aliphatic polyester, the aromatic polyester-aliphatic polyester copolymer, and the polycarbonate. Since the polylactic acid is a resin produced from a plant, even when the polylactic acid is burnt to generate carbon dioxide, an amount of the carbon dioxide is equivalent to that of the carbon dioxide which had originally been in the atmosphere. Therefore, a balance of carbon dioxide in the atmosphere is plus or minus zero, that is, a gross weight of CO₂ in the atmosphere does not increase. Based on such an idea, the polylactic acid is a so-called “carbon neutral” material and an effective material to prevent global warming. In addition, the polylactic acid has a high melting point, can be melt-molded, and generates a low heat in combustion. There is another advantage that environmental load is low since the polylactic acid is finally decomposed by bacteria and so on even when the polylactic acid is thrown into the nature. The polylactic acid is also excellent in low mass-production cost which can be reduced with high possibility as low as that of general purpose plastic. Moreover, the polylactic acid can be produced and supplied not from petroleum resources which are predicted to be depleted in the future, but from permanently regenerable plants. Furthermore, the polylactic acid is highly safer and advantageous in view of resource recycling.

For instance, the inorganic metal hydroxide includes magnesium hydroxide, aluminium hydroxide, dawsonite (NaAlCO₃(OH)₂), and so on. One kind or a combination of two or more kinds of the inorganic metal hydroxides may be mixed into the resin composition of the invention.

The metal ion trap includes a substance which traps metal ions by means of chemical reaction and a substance which traps metal ions by means of physisorption. For instance, the substance which traps the metal ions by the chemical reaction includes boron, anhydrous boric acid, phosphorus compound (for instance, phosphate and phosphite), and so on while the substance which traps the metal ions by the physisorption includes zeolite and so on. One kind or a combination of two or more kinds of the metal ion traps may be mixed into the resin composition of the invention.

The resin composition of the invention preferably contains, per 100 parts by weight of the ester linked polymer, 1-200 parts by weight of the inorganic hydroxide flame retardant and 0.0001-50 parts by weight of the metal ion trap. In particular, the resin composition preferably contains, per 100 parts by weight of the ester linked polymer, 50-150 parts by weight of the inorganic hydroxide flame retardant and 0.0002-20 parts by weight of the metal ion trap. When ratio of the mixed inorganic hydroxide flame retardant is too low, the molded product cannot have excellent flame retardancy. Meanwhile, when the ratio of the mixed inorganic hydroxide flame retardant is too high, the molded product may become fragile. When the ratio of the mixed metal ion trap is too low, the ester containing polymer reacts with the metal hydroxide to generate a solid substance. Therefore, it is impossible to mold the resin composition. Meanwhile, when the composite ratio of the metal ion trap is too high, a molded product may become fragile.

Besides the ester linked polymer, the inorganic hydroxide flame retardant, and the metal ion trap, another component may be contained in the resin composition of the invention. For instance, another component may be contained to improve various properties, such as formability, mechanical strength, and so on within a range not to obstruct to achieve the object of the invention. For instance, a strengthening agent, a polymer other than the ester linked polymer, a nucleating agent, a plasticizer, a stabilizer (an anti-oxidant, a ultraviolet absorber, and so on), a mold release agent (fatty acid, fatty acid metal salt, oxy fatty acid, fatty acid ester, partially saponified aliphatic ester, paraffin, low molecular weight polyolefine, fatty acid amide, alkylenebisfatty acid amide, aliphatic ketone, fatty acid ester of lower alcohol, fatty acid ester of polyhydric alcohol, fatty acid ester of polyglycol, modified silicone), and so on may be mixed. In addition, a coloring agent including a dye and a pigment may be added.

As the reinforcement, a fibrous, a tabular, a granule, or a powdered one may be mixed to strengthen mechanical properties (shock resistance and rigidity) of a thermoplastic resin. Complete examples are: an inorganic fiber reinforcement such as glass fiber, asbestos fiber, carbon fiber, graphite fiber, metallic fiber, potassium titanate whisker, aluminum borate whisker, magnesium whisker, silicon whisker, wollastonite, sepiolite, asbestos, slag fiber, Zonolite, ellestadite, gypsum fiber, silica fiber, silica alumina fiber, zirconia fiber, boron nitride fiber, silicon nitride fiber, and boron fiber; synthetic fibrous reinforcement such as polyester fiber, nylon fiber, acrylic fiber, regenerated cellulose fiber, and acetate fiber; a natural fiber such as kenaf, ramie, cotton, jute, hemp, sisal, Manila hemp, flax, linen, and silk; an organic fiber reinforcement such as sugarcane, wood pulp, wastepaper, used paper, and wool; a tabular or particulate inorganic filling such as glass flake, non-swelling mica, graphite, metal leaf, ceramic bead, talc, clay, mica, sericite, zeolite, bentonite, dolomite, kaolin, finely-powdered silicic acid, feldspar powder, potassium titanate, cirrus balloon, calcium carbonate, magnesium carbonate, barium sulfate, calcium oxide, aluminum oxide, titanium oxide, aluminium silicate, silicon oxide, gypsum, novaculite, dawsonite, and white clay, and so on. Among these reinforcements, a natural fiber, a glass fiber, and an inorganic filling are preferable to take advantages of carbon neutrality and biodegradability of the polylactic acid. In particular, a kenaf is preferable among the natural fibers since the kenaf grows fast so as to be steadily supplied as an industrial raw material.

Moreover, the reinforcement may be surface-coated or focus-processed by a thermoplastic resin, a thermosetting resin, a coupling agent, and so on.

The reinforcement is effective to improve anti-drip performance in flame retardancy. However, too much reinforcement decreases brittleness obtained by a molding process.

Besides the ester linked polymer, either of the thermoplastic polymer or the thermosetting polymer may be used as the polymer. However, the thermoplastic polymer is preferable in consideration of moldability. Specific examples are polyolefme such as low-density polyethylene, high density polyethylene, and polypropylene, polyamide, polystyrene, polyacetal, polyurethane, aromatic and aliphatic polyketone, polyphenylene sulfide, polyether ether ketone, polyimide, thermoplastic starch resin, polystyrene, acricresin, AS resin, ABS resin, AES resin, ACS resin, AAS resin, polyvinyl chloride resin, polyvinylidene chloride, vinylester resin, polyurethane, MS resin, polycarbonate, polyarylate, polysulfone, polyether sulfone, phenoxy resin, polyphenylene oxide, poly-4-methylpentene-1, polyether imide, cellulose acetate, polyvinyl alcohol, unsaturated polyester, melamine resin, phenol resin, urea resin, and so on. Other specific examples are ethylene-propylene copolymer, ethylene-propylene-nonconjugated diene copolymer, ethylene-butene-1 copolymer, various kinds of acrylic rubbers, ethylene-acrylic acid copolymer and alkali metal salt thereof (so-called ionomer), ethylene-glycidyl (meta)acrylate copolymer, ethylene-alkyl acrylate copolymer (for instance, ethylene-ethyl acrylate copolymer and ethylene-butyl acrylate copolymer), acid modified ethylene-propylene copolymer, diene rubber (for instance, polybutadiene, polyisoprene, and polychloroprene), a copolymer of diene and vinyl monomer, (for instance, styrene-butadiene random copolymer, styrene-butadiene block copolymer, styrene-butadiene-styrene block copolymer, styrene-isoprene random copolymer, styrene-isoprene block copolymer, styrene-isoprene-styrene block copolymer, grafting copolymerization product of polybutadiene and styrene, butadiene-acrylonitrile copolymer), polyisobutylene, a copolymer of isobutylene and butadiene or isoprene, natural rubber, thiokol rubber, polysulfide rubber, acrylic rubber, polyurethane rubber, polyether rubber, epichlorohydrin rubber, and so on. Still further examples include polymers with various degrees of crosslinking, polymers with various microstructures, such as a cis structure and a trans structure, a polymer with a vinyl group, polymers with a various average particle diameters (in the resin composition), and a multilayered polymer which is so-called a core shell rubber, which includes a core layer and one or more shell layers covering the core layer, and in which adjacent layers are formed of different polymers. In addition, a core shell rubber containing silicone compound may be used. The polymers may be used alone or in combination of two or more thereof.

The nucleating agent is effective to improve moldability, heat resistance, and flame retardancy. Anyone mixed as a nucleating agent for a polymer can be used with no special limitation. The nucleating agent includes an inorganic nucleating agent and an organic nucleating agent. For instance, the inorganic nucleating agent includes talc, kaolinite, montinorillonite, synthetic mica, clay, silica, graphite, carbon black, zinc oxide, magnesium oxide, titanium oxide, calcium sulfide, boron nitride, calcium carbonate, barium sulfate, aluminum oxide, neodymium oxide, and metal salt of phenylphosphonate, and so on.

For instance, the organic nucleating agent includes: organic carboxylate metal salt such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, sodium cyclohexane carboxylate; salt of organic sulfonic acid such as sodium p-toluenesulfonate and sodium sulfoisophthalate; carboxylic amide such as stearic acid amide, ethylenebislauric acid amide, palmitic acid amide, hydroxystearic acid amide, eruic acid amide, and trimesic acid tris(t-butyramide), benzylidene sorbitol and derivatives thereof; phosphorus compound metal salt such as sodium-2,2′-methylenebis(4,6-di-t-butylphenyl)phosphate, 2,2-methylbis(4,6-di-t-butylphenyl)sodium, and so on. The inorganic nucleating agent or the organic nucleating agent may be used alone or in combination of two or more thereof.

In a case where the resin composition of the invention contains the nucleating agent, preferably 0.005-5 parts by weight, and more preferably 0.1-1 part by weight of the nucleating agent is contained per 100 parts by weight of the ester linked polymer.

Moreover, the resin composition of the invention may contain a plasticizer so as to be molded into a necessary shape with predetermined moldability without losing flame retardancy. Any plasticizer commonly used to mold a polymer can be used as the plasticizer with no special limitation. For instance, the plasticizer includes a polyester plasticizer, a glycerol plasticizer, a polyvalent carboxylic acid ester plasticizer, a polyalkylene glycol plasticizer, epoxy plasticizer, and so on.

Specific examples of the polyester plasticizer are a polyester formed of an acid component such as adipic acid, sebacic acid, terephthalic acid, isophthalic acid, naphthalenedicarboxylic acid, diphenyldicarboxylic acid, and rosin, with diol component such as propylene glycol, 1,3-butanediol, 1,4-butanediol, 1,6-hexanediol, ethylene glycol, and diethylene glycol, polyester formed of hydroxylcarboxylic acid such as polycaprolactone, and so on. These polyesters may be end-capped by monofinctional carboxylic acid or monofunctional alcohol, or by epoxy compound or the like.

Specific examples of the glycerol plasticizer are glycerol monoacetomonolaurate, glycerol diacetomonolaurate, glycerol monoacetomonostearate, glycerol diacetomonoolate, and glycerol monoacetomonomontanate, and so on.

Specific examples of the polyvalence carboxylate plasticizer are phthalate such as dimethyl phthalate, diethyl phthalate, dibutyl phthalate, dioctyl phthalate, diheptyl phthalate, dibenzyl phthalate, and butylbenzyl phthalate, trimellitate such as tributyl trimellitate, trioctyl trimellitate, and trihexyl trimellitate, adipate such as diisodecyl adipate, n-octyl-n-decyl adipate, methyl diglycol butyl diglycol adipate, benzylmethyl diglycol adipate, and benzylbutyl diglycol adipate, citrate such as triethyl acetyl citrate and tributyl acetylcitrate, azelate such as di-2-ethylhexyl azelate, dibutyl sebacate, di-2-ethylhexyl sebacate, and so on.

Specific examples of the polyalkylene glycol plasticizer are polyalkylene glycol such as polyethylene glycol, polypropylene glycol, poly(ethylene oxide-propylene oxide) block and/or random copolymer, polytetramethylene glycol, bisphenol-ethylene oxide addition polymer, bisphenol-propylene oxide addition polymer, and bisphenol-tetrahydrofuran addition polymer, and terminal epoxidized compound, terminal esterified compound, and terminal etherified compound of the polyalkylene glycol, and so on.

In general, the epoxy plasticizer is epoxy triglyceride or the like formed of alkyl epoxy stearate and soybean oil. Meanwhile, a so-called epoxy resin, which is made from mainly bisphenol A and epichlorohydrin as raw materials, may be used.

Specific examples of other plasticizers are benzoate of aliphatic polyol such as neopentyl glycol dibenzoate, diethylene glycol dibenzoate, and triethylene glycol di-2-ethyl butyrate, fatty acid amide such as stearic acid amide, aliphatic carboxylate such as butyl oleate, oxyacid ester such as methyl acetyl ricinolate and butyl acetyl ricinolate, pentaerythritol, various sorbitols, and so on.

In a case where the resin composition of the invention contains the plasticizer, preferably 0.005-5 parts by weight, and more preferably 0.01-1 part by weight of the plasticizer are contained per 100 parts by weight of the ester linked polymer.

The resin composition of the invention is useful as a material of an electronic device component which requires high flame retardancy. The ester linked polymer, the inorganic hydroxide flame retardant and the metal ion trap, and various additives, which are mixed as needed, such as the reinforcement and the flame retardant are directly supplied to an injection molding apparatus and molded into a necessary shape. Thus, an electronic device transparent component of a resin composition of the invention can be produced. The injection molding apparatus disperses and mixes ingredients to be mixed, in a cylinder with high shear stress in order to homogeneously mix the ingredients. In addition, the injection molding apparatus includes a screw having a mixing mechanism which can control how long the ingredients to be melted and mixed stay in the cylinder in order to sufficiently melt and mix the ingredients. As the mixing mechanism, a portion having high shearing ability such as a pin, a protrusion, a rotor, and a barrier may be provided in the screw. High shear stress is given to the ingredients to be melted and mixed which pass through the portion so that the ingredients are homogeneously melted. For instance, a screw equipped with a dulmage which has high dispersion effect (see Japanese Laid-Open Patent Application Publication JP H05-237913 A and Japanese Examined Patent Application Publications JP H06-73897 B and JP H06-73898 B) may be used. Moreover, ones described in Japanese Laid-Open Patent Application Publications JP H06-91726 A and JP 2000-33615 A may be used. For instance, in the screw with the dulmage, fins with the same length in a screw axis direction are arranged in the screw rotation direction on an edge of a full-flighted screw.

### EXAMPLES

Next, the invention will be more specifically described with examples and reference examples of the invention. It is noted that the following examples do not limit the invention.

### Example 1

Polylactic acid (H-100, manufactured by Mitsui Chemicals Ltd.), magnesium hydroxide (MGZ-5, Sakai Chemical Industry Co., Ltd.) as a flame retardant, and boron (Wako Pure Chemical Industries, Ltd.) as a metal ion trap were melted and mixed at 220° C. to be molded into an impact bar with 3.2 mm×72mm×12.7 mm.

### Example 2

An impact bar was molded similarly to Example 1 except that magnesium hydroxide (FR×100; Shin-Etsu Chemical Co., Ltd.) and zeolite (# 150; Nitto Funka Kogyo K.K.) were respectively used as the flame retardant and the metal ion trap.

### Comparative Example 1

The polylactic acid (H-100, manufactured by Mitsui Chemicals Ltd.) solely was melted and mixed at 200° C. to be molded similarly to Example 1 into an impact bar with 3.2 mm thickness.

### Comparative Example 2

An impact bar was molded similarly to Example 1 except that the metal ion trap was not added.

For the impact bars which had been produced in Examples 1-2 and Reference Examples 1-2, combustion tests were conducted in compliance with the UL standard by the following means. The results are shown below.

Combustion Test

Each of the two impact bars were placed on flame of a burner for 10 seconds and then drawn away from the burner in order to see whether the flame extinguished. This test was repeated twice. “Self-extinguished” indicates a case where the impact bar kept burning only for less than 30 seconds. “Dripped” indicates a case where the impact bar melted and dropped.

TABLE 1

| | Flame | Metal Ion | 1st Combustion | 2nd Combustion |
|---|---|---|---|---|
| | Retardant | Trap | Test | Test |
| Example 1 | MGZ-5 | Boron | Self- | Self- |
| | 57% | 2% | extinguished | extinguished |
| Example 2 | FRX100 | Zeolite | Self- | Self- |
| | 57% | 2% | extinguished | extinguished |
| Comparative | — | — | Self- | Self- |
| Example 1 | | | extinguished, | extinguished, |
| | | | Dripped | Dripped |

| | | | |
|---|---|---|---|
| Comparative | MGZ-5 | — | Not moldable |
| Example 2 | 57% | | |

As for a resin composition of the invention, a metal hydroxide flame retardant which has little environmental load is mixed with an ester linked polymer. Accordingly, the resin composition can be molded without a solid substance generated by reaction of the ester linked polymer with the metal hydroxide flame retardant. As a result, the resin composition of the invention is melted and molded through processes for melting and molding a resin such as injection molding or extrusion molding into a component with an excellent flame-retardancy because of the metal hydroxide flame retardant.

Moreover, the resin composition as a material can be melted and molded into an electronic device component of the invention without a solid substance generated by reaction of the ester linked polymer with the metal hydroxide flame retardant. Therefore, the electronic device component has excellent flame-retardancy. In particular, polylactic acid or polylactic acid copolymer used as the ester linked polymer is produced from not a fossil resource but a plant material. Therefore, the electronic device component is effective to prevent global warming since it is produced from mainly the polylactic acid which is a carbon neutral material. Moreover, when the electronic device component is burnt, generated heat is low. Even when the electronic device component is thrown into the nature, there is an advantage that environmental load is low since the polylactic acid is finally decomposed by bacteria and so on.

### INDUSTRIAL APPLICABILITY

In the invention, an electronic device component is a component which requires flame-retardancy to be a portion of an electronic device. More specifically, the electronic device component is a component which requires excellent flame-retardancy provided in an electronic photocopier, a printer, a facsimile, or the like.

While the described embodiments represent the preferred forms of the present invention, it is to be distinctly understood that the invention is not limited thereto but may be otherwise variously embodied within the spirit and scope of the following claims.

What is claimed is:

1. A resin composite material comprising an ester linked polymer, an inorganic hydroxide flame retardant, and a metal ion trap.

2. The resin composite material as claimed in claim 1, wherein at least one kind of the ester linked polymer is selected from a group consisting of aromatic polyester, aliphatic polyester, aromatic polyester-aliphatic polyester copolymer, and polycarbonate.

3. The resin composite material as claimed in claim 2, wherein at least one kind of the inorganic hydroxide flame retardant is selected from a group consisting of magnesium hydroxide, aluminium hydroxide, and dawsonite.

4. The resin composite material as claimed in claim 2, wherein at least one kind of the metal ion trap is selected from a group consisting of boron, anhydrous boric acid, phosphate, phosphite, and zeolite.

5. The resin composite material as claimed in claim 3, wherein at least one kind of the metal ion trap is selected from a group consisting of boron, anhydrous boric acid, phosphate, phosphite, and zeolite.

6. The resin composite material as claimed in claim 2, comprising:
100 parts by weight of the ester linked polymer;
1-200 parts by weight of the inorganic hydroxide flame retardant; and
0.0001-50 parts by weight of the metal ion trap.

7. The resin composite material as claimed in claim 3, comprising:
100 parts by weight of the ester linked polymer;
1-200 parts by weight of the inorganic hydroxide flame retardant; and
0.0001-50 parts by weight of the metal ion trap.

8. The resin composite material as claimed in claim 4, comprising:
100 parts by weight of the ester linked polymer;
1-200 parts by weight of the inorganic hydroxide flame retardant; and
0.0001-50 parts by weight of the metal ion trap.

9. The resin composite material as claimed in claim 5, comprising:
100 parts by weight of the ester linked polymer;
1-200 parts by weight of the inorganic hydroxide flame retardant; and
0.0001-50 parts by weight of the metal ion trap.

10. An electronic device component comprising the resin composite material as claimed in claim 1.

11. An electronic device component comprising the resin composite material as claimed in claim 2.

12. An electronic device component comprising the resin composite material as claimed in claim 3.

13. An electronic device component comprising the resin composite material as claimed in claim 4.

14. An electronic device component comprising the resin composite material as claimed in claim 5.

15. An electronic device component comprising the resin composite material as claimed in claim 6.

16. An electronic device component comprising the resin composite material as claimed in claim 7.

17. An electronic device component comprising the resin composite material as claimed in claim 8.

18. An electronic device component comprising the resin composite material as claimed in claim 9.
